(19) United States
(12) Patent Application Publication
(10) Pub. No.: US 2004/0022219 A1
(43) Pub. Date: Feb. 5, 2004

(54) Wireless system containing a first network and a second network

(76) Inventors: Stefan Mangold, Aachen (DE); Bernhard Walke, Wuerselen (DE); Wolfgang Budde, Aachen (DE); Joerg Habetha, Aachen (DE)

Correspondence Address: Philips Electronics North America Corporation, Corporate Patent Counsel, 580 White Plains Road, Tarrytown, NY, 10591, US

(21) Appl. No.: 10/181,164

(22) PCT Filed: Nov. 15, 2001
(86) PCT No.: PCT/EP01/13331

(30) Foreign Application Priority Data
Nov. 17, 2000 (EP) 00125110.7

(51) Int. Cl. H04L 12/28

(52) U.S. Cl. 370/336; 370/335; 370/338

(57) ABSTRACT

The invention defines a combined and harmonized protocol for wireless LANs based on the combination of ETSI BRAN HiperLAN/2 protocols with IEEE 802.11a protocols. The new HipeLAN/2 enhanced AP (H/2eAP) will—in addition to its standard HiperLAN/2 operation—also work as Point Coordinator of 802.11a, or is supported by a cooperative Point Coordinator of 802.11. The H/2eAP sends a corporate beacon at the H/2 Target Beacon Transmission Time (H/2 TBTT) with setting the CfpDurRemaining parameter to (a multiple of) 2 ms. Upon receiving this beacon by stations of the 802.11a BSS, the stations recognize it as a foreign BSS beacon, extract and evaluate the CfpDurRemaining parameter and thus set timers to the appropriate duration, not to initiate any data transmission during the respective time. After sending this beacon the H/2eAP is able to initiate the transmission of its H/2 MAC frame without underlying interference from the neighbor 802.11a system and without delay of the initial H/2 corporate beacon. The H/2 MAC frame will be embedded in the 802.11 Contention Period (CP) right after the Contention Free Period (CFP). Because the CP before the H/2 MAC frame is either controlled by the H/2eAP or by a cooperative PC, it can be guaranteed that there is no delay of the H/2 corporate beacon transmission. As a result, QoS in H/2 can be supported. The resulting time sequence can be divided into three parts, (1) the “802.11e CFP” with limited Quality of Service, (2) the “HiperLAN/2 MAC” frame with full support of Quality of Service, and (3) the 802.11e CP without any Quality of Service support. All three parts together form the so-called corporate superframe, which is periodically repeated in time.

The invention relates to a system containing a first network with assigned first stations and a second network with second stations. The first network operates according to a first standard, e.g. the HiperLAN/2-standard and the second network operates according to a second standard, e.g. the IEEE 802.11e-standard. Both standards are wireless standards and work at the 5 GHz band.

According to the state of the art the first network and the second network are designed independently from each other. If e.g. a second station of the second network comes within the range of first stations of the first network, this could lead to interferences.

Therefore it is an object of the invention to provide a system, which allows coexistence of two different networks within the same frequency range.

This object is achieved in that a system containing a first network with assigned first stations and a second network with second stations is provided, whereby a hybrid-coordinator sends a beacon at a target beacon transmission time with setting a first parameter, whereby upon receiving this beacon by second stations, the second stations extract and evaluate the first parameter and thus set timers to a appropriate duration, not to initiate any data transmission during the respective time, whereby after sending this beacon the hybrid coordinator is able to initiate the transmission of data of the first network without underlying interference from the second network.

The gist of the invention is to provide the system with a hybrid coordinator, which coordinates the access of the first and the second network on a common channel.

The invention defines a combined and harmonized protocol for wireless LANs.

In the example that the first network is a network according to the HiperLAN/2-standard and the second network is a network according to the IEEE 802.11e-standard, a possible solution could be as follows:

Based on the combination of ETSI BRAN HiperLAN/2 protocols with IEEE 802.11a protocols, a new HiperLAN/2 enhanced AP (H/2eAP) will work as hybrid coordinator and—in addition to its standard HiperLAN/2 operation—also work as Point Coordinator of 802.11a, or is supported by a cooperative Point Coordinator of 802.11.

The H/2eAP sends a corporate beacon at the H/2 Target Beacon Transmission Time (H/2 TBTT) with setting the CfpDurRemaining parameter to (a multiple of) 2 ms. Upon receiving this beacon by stations of the 802.11a BSS, the stations recognize it as a foreign BSS beacon, extract and evaluate the CfpDurRemaining parameter and thus set timers to the appropriate duration, not to initiate any data transmission during the respective time. After sending this beacon the H/2eAP is able to initiate the transmission of its H/2 MAC frame without underlying interference from the neighbor 802.11a system and without delay of the initial H/2 corporate beacon. The H/2 MAC frame will be embedded in the 802.11 Contention Period (CP) right after the Contention Free Period (CFP). Because the CP before the H/2 MAC frame is either controlled by the H/2eAP or by a cooperative PC, it can be guaranteed that there is no delay of the H/2 corporate beacon transmission. As a result, QoS in H/2 can be supported.

The resulting time sequence can be divided into three parts, (1) the “802.11e CFP” with limited Quality of Service, (2) the “HiperLAN/2 MAC” frame with full support of Quality of Service, and (3) the 802.11e CP without any Quality of Service support. All three parts together form the so-called corporate superframe, which is periodically repeated in time.

Interpreting a HiperLAN/2 (H/2) Access Point (AP) as an PC that only operates in the Contention Free Period (CFP), by at the same time not allowing its BCH to be delayed, the H/2 enhanced AP (H/2eAP) concept may apply. The H/2eAP must follow some rules according to 802.11e, in order to

coexist with other 802.11 BSS operating in PCF or DCF,

allow one single type of AP to coordinate channel access of Mobile Terminals (MT) of H/2 and Stations (STA) of 802.11e,

seamlessly extend 802.11e and H/2 towards a merged standard, by allowing three different types of access, the 802.11 PCF, the H/2 centrally controlled MAC frame, and the 802.11 DCF.

This concept does not require to give up one of the two individual standards, but may be a candidate for a single global standard for WLANs and WPANs at the 5 GHz band. The H2eAP allows (a) the operation according to H/2, (b) the operation according to the infrastructure based mode of 802.11 (PCF/DCF), as well as (c) the operation as independent BSS of 802.11 (DCF).

In case a H/2 system has detected an 802.11 system sharing the same frequency channel and thus underlying interference, the H/2eAP (HiperLAN/2 enhanced AP) should enable the enhanced functionality and behave as described in the following. However, basic resource management schemes as DFS (DCS in 802.11 TGh) will drastically help to avoid such mutual interference. Within the scenarios under discussion in this document, it is assumed that every station and terminal is in range of all of the other stations/terminals, so no hidden-station problem applies.

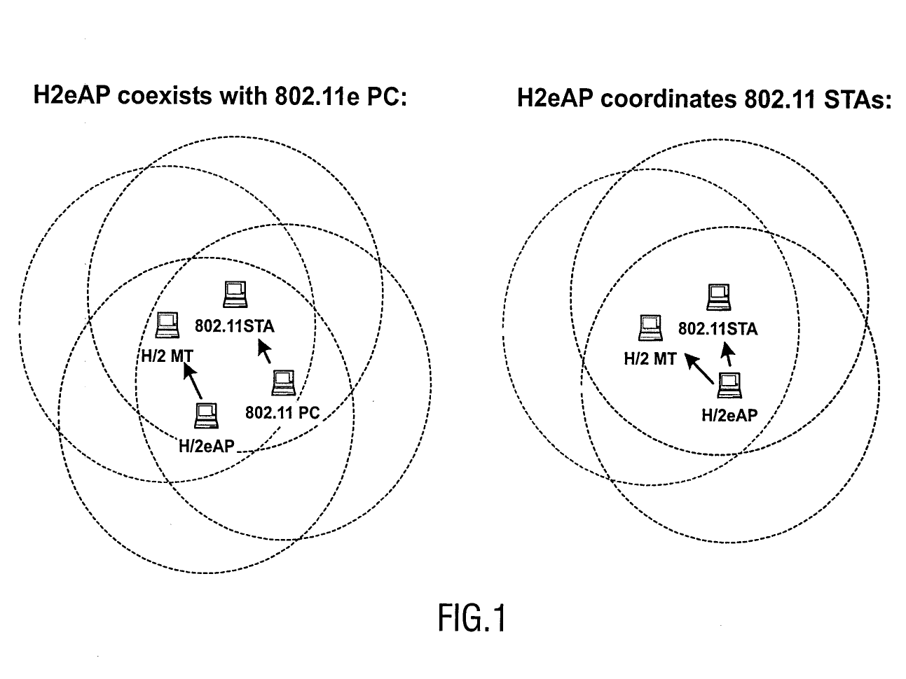

FIG. 1 shows two applications of the H/2eAP approach: the H/2eAP may coexist with other BSS based on IEEE 802.11e (left); if full interoperability is required, the H/2eAP may take over the Point Coordination.

Before explaining the H/2eAP concept, some Network Allocation Vector (NAV) aspects of 802.11 are reviewed, as the H/2eAP concept heavily relies on the NAV.

In 802.11, a beacon not of the own BSS but sent by a PC of a foreign BSS is interpreted in the way that the NAV is set by all 802.11 STAs including the 802.11 AP for the remaining duration of the CFP (as indicated by the CfpDurRemaining parameter within the beacon). Because of the set NAVs, the announced contention free period of the foreign BSS will not be interrupted and interfered by, e.g., data frames sent under control of the DCF in the own BSS. Because the stations have set their NAV, they will not initiate a frame exchange until the foreign BSS has finished its CFP, i.e., the remaining duration of the CFP, CfpDurRemaining, has expired. One exception has to be taken into account, when considering overlapping BSS, each with a PC available, and assuming that the PCs cannot hear each other: upon being polled by its own (hidden) PC, a station will send an ack frame to indicate that it has received the poll. But, because the station has set its NAV as stated above, it will not send any data in response to the poll. Strictly speaking, this ack frame can collide with a frame exchange in the ongoing PCF of the overlapping BSS. A possible solution to this problem is the introduction and usage of the Overlapping NAV (ONAV), as discussed at 802.11 TGe [2]. Upon setting this ONAV in reaction to a received frame of a foreign BSS, an 802.11 station will not even respond to a poll by its own PC as long as the overlapping BSS has its PCF ongoing, i.e., ONAV< >0.

Keeping this in mind, the extended functionality of the H/2eAP can be described as follows.

The H/2eAP sends a corporate beacon at the H/2 Target Beacon Transmission Time (H/2 TBTT) with setting the CfpDurRemaining parameter to (a multiple of) 2 ms. Upon receiving this beacon by stations of the 802.11a BSS, the stations recognize it as a foreign BSS beacon, extract and evaluate the CfpDurRemaining parameter and thus set their ONAV to the appropriate duration. After sending this beacon the H/2eAP is able to initiate the transmission of its H/2 MAC frame without underlying interference from the neighbor 802.11a system and without delay of the initial H/2 corporate beacon.

The H/2 MAC frame will be embedded in the 802.11 Contention Period (CP) right after the CFP.

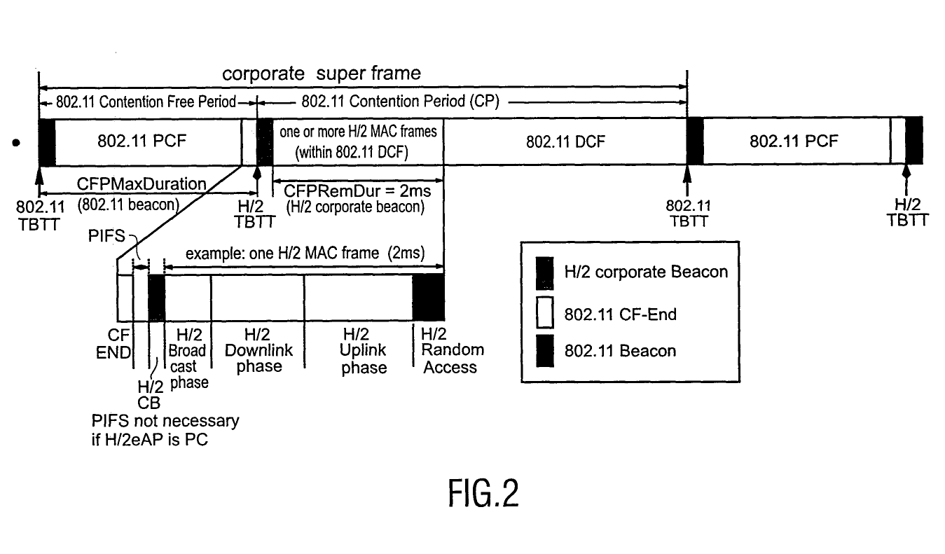

The resulting time sequence, as shown in FIG. 2 (FIG. 2 shows a new frame structure of the H/2eAP), can be divided into three parts, the 802.11e CFP, the H/2 MAC frame, and the 802.11e CP. All three parts together form the so-called corporate superframe, which is periodically repeated in time.

First Part: 802.11e CFP.

The first part of the corporate superframe is the 802.11 CFP. At the 802.11 TBTT a 802.11 beacon sent by the PC introduces this period. Note that this PC may well be the H/2eAP itself. If the beacon is sent by a competing PC, it is assumed that both the PC and the H/2eAP are in cooperative equilibrium, i.e., the PC follows rules to support the corporate superframe.

Without enabling a so-called time-gap control mechanism (each station checks if there is enough time left for the frame exchange procedure before a dedicated point of time, which is here the 802.11 TBTT) this initial beacon of course may be delayed. This is because of the possibility of a busy channel at the 802.11 TBTT. The maximum duration of the CFP is indicated in the CFPMaxDuration field of the beacon. Note, that the resulting maximum duration of the CFP is calculated taking the 802.11 TBTT as the reference point in time and adding the CFPMaxDuration. Thus, a beacon delay at the beginning of the CFP results in a foreshortened contention free period. Or, to say it in other words, the point in time the CFP ends is fixed and underlies no delay. The worst case delay of a delayed beacon has to be taken into account, if, e.g., another 802.11 BSS is overlapping and one of its stations may have introduced a frame exchange without considering the TBTT, i.e., without the time-gap control mechanism. Note, that this problem does only occur with hidden-stations.

The PC schedules a broadcast CF_end frame to be the last frame in the CFP and to end it. Referring to the IEEE 802.11 standard of 1999 [2], a PC may finish the CFP earlier, e.g., if there is not enough remaining time for polling a station or no station is left on its polling list. In this case, the PC would send a CF_end frame and end the CFP earlier than the maximum CFP duration. Within the H/2eAP approach, in order to integrate the H/2 MAC frame into the 802.11 Contention Period, the PC must not end the CFP earlier. Further, if the PC calculates that there is not enough time to poll a station and receive its data, it is quite for the remaining time before it schedules the CF_end. The PC could also send the known nullframes to indicate the channel as busy for other, overlapping BSS. As a response to the nullframes, the polled station will send a cf_ack frame. Doing so, the probability of colliding frames sent by stations that do not receive the beacon, i.e. hidden stations, can be reduced, because from receiving cf_ack frames a station understands that there is an active CFP. Once again recall that in this document one 802.11 BSS is considered with all stations in range of each other. The end of this first part of the corporate superframe is clearly defined and underlies no delay.

Second Part: H/2 MAC Frame(s).

After receiving the CF_end frame by all 802.11 STA, they reset their NAV and the Contention Period starts. This can be referred to as the second part of the 802.11 superframe. Under the control o the DCF, all 802.11 STAs try to gain access to the channel if they have data to transmit. They attempt to sense the channel as idle for a duration of DIFS; if so, they start the back-off procedure. The H/2eAP also receives (if not sent by itself) the CF_end frame. Moreover, upon receiving this frame and waiting a shorter inter-frame space (IFS) than DIFS, e.g. PIFS, at the H/2 TBTT it broadcasts a H/2 corporate beacon. Note, that this point in time is clearly defined and underlies no delay. The corporate beacon has the same frame structure as an 802.11 beacon. The H/2eAP sets the CFPDurRemaining value that indicates the remaining duration of the introduced CFP to multiples of 2 ms, in the example of FIG. 2 to 2 ms. As a result of the shorter IFS, the H/2eAP has priority over the 802.11 STA, the latter sense the channel as busy, freeze their back-off counter and retrieve from accessing the channel. The H/2 corporate beacon is received by the 802.11 STAs and the 802.11 PC (if there is one), and is interpreted as a beacon of a neighbor, foreign BSS. Furthermore, because the CFPDurRemaining parameter within this beacon is not equal zero, they set their NAV/ONAV to this value. The reason for this is that they believe the foreign BSS is introducing its CFP and running it for the indicated remaining duration. The H/2eAP now schedules one or more of its 2 ms lasting H/2 MAC frame, beginning with a broadcast phase and ending, in general, with a random access phase. All the 802.11 stations and the 802.11 PC have set their NAV/ONAV and will cause no interference for the whole duration of the H/2 MAC frame. As stated above, without the ONAV principle, a collision may occur when stations of another 802.11 BSS response to a poll by their PC.

Third Part: 802.11e CP

Once this remaining duration has expired, all 802.11 STA reset their NAV/ONAV and continue operating under the rules of the DCF. This is the third and last part within the corporate superframe structure. An enabled time-gap control procedure would eliminate the beacon transmission delay problem at the next TBTT, the beginning of the following CFP.

Requirements, Extensions of the Two Standards

The 802.11 system with the PCF enabled (as part of the H/2eAP, or as cooperative PC) has to spend at least the time needed for embedding the H/2 MAC frame plus the minimum DCF duration in the contention period. This requirement results in an appropriate setting of the following 802.11 parameter:

CFPeriod, which represents the time between two 802.11 TBTTs at which a CFP is scheduled to begin. Actually, it indicates the integral number of DTIM intervals between the start of CFPs. Within ComNets' WARP2 simulation environment, a DTIM interval is equal to a beacon interval. Because the latter indicates the time (in TU) between two beacons and within our scenarios a beacon always introduces a CFP, the CFPeriod can be referred to as the time in TU between two 802.11 TBTTs.

CFPMaxDuration, which indicates the maximum time, in time units (TU), of the CFP that is generated by this PCF. The stations use this value to set their NAV at the TBTT of beacons that introduce the CFP.

The 802.11a STAs are further required to perform according to 802.11e including the ONAV principle, and have to always check TBTTs before transmitting any burst (time-gap control procedure). the CF_end burst sent by the PC needs to support the strict timing at the end of the first part of the corporate superframe. The PC must not use the option to end its own CFP earlier than the CFPMaxDuration.

The functionality of a H/2 AP to become a H/2eAP concentrates on the following extensions: Once detected a 802.11 system, the H/2eAP has to listen for a CF_end frame sent by the 802.11 PC.

After receiving this frame and waiting for a shorter time than DIFS, e.g. PIFS, a corporate beacon is to be sent by this H/2eAP. Within this corporate beacon the parameter CFPDurRemaining has to be set to an appropriate value, e.g., 2 ms or multiple of this value. Hereafter, one (or more, if the CFPDurRemaining parameter was set to multiple of 2 ms) H/2 MAC frame(s) is (are) transmitted without any delay or interference.

After the time as indicated by the CFPDurRemaining has expired, the H/2eAP has to switch into the absence mode. This point in time was announced to the H/2 MTs by the H/2 AP within the first H/2 MAC frame transmitted.

The time the H/2eAP is in absence mode is a multiple of the duration of a H/2 MAC frame according to the corporate super frame, i.e. n ms with n=1, 2, 3, . . . The H/2 system has to detect an alien system working in the same vicinity and on the same frequency channel. Furthermore, it has to detect not only a foreign system but identify it as a 802.11 system. Generally, a synchronization preamble is sent before every burst and this sequence is unique for both systems, H/2 and 802.11. Every device on this frequency channel in the shared environment detecting this preamble at a power level above a minimum sensitivity threshold tries to synchronize on this sequence by means of a correlator. In case the synchronization attempt succeeds, it is assumed that the burst is from the own system and therefore is evaluated. Taking this as a basis, it is necessary for the H/2eAP not only to correlate to a H/2 burst, but also to detect a foreign burst as a 802.11 burst, where applicable.

It is important to realize that the duration between two H/2 TBTT is clearly defined. It can be guaranteed that there is no delay of the H/2 corporate beacon transmission. As a result, QoS in H/2 can be supported. The H/2 MAC frame is embedded in the 802.11 Contention Period every H/2 TBTT repetition interval (H/2 TBTT RI). The H/2 TBTT RI can be calculated as the reciprocal value of the duration between two H/2 TBTTs. Coexistence at the same frequency channel with other H/2 system cannot be supported. The coexistence with other 802.11a systems is fully supported.

The spectrum efficiency of the H/2eAP is subject of current investigations, the strict operation according to 802.11e with limited DCF periods may be a high price to be paid. Periodic corporate beacons sent during the CP and CFP in order not to loose synchronization between H/2eAP and H/2 MTs will further reduce throughput efficiency. As in the on-going discussions at 802.11 TGe, hidden stations need to be further examined.

References:

[1] G. Cervello and S. Choi, “Collision Avoidance for Overlapping BSSs in 802.11”, IEEE doc 802.11-00/194

[2] IEEE, “Reference number ISO/IEC 8802-11:1999(E) IEEE Std 802.11, 1999 edition. International Standard [for] Information Technology—Telecommunications and information exchange between systems—Local and metropolitan area networks—Specific Requirements—Part 11: Wireless LAN Medium Access Control (MAC) and Physical Layer (PHY) specifications”, 1999.

Used Abbreviations:

| | |
|---|---|
| AP | Access Point |
| BCH | Broadcast CHannel |
| BRAN | Broadband Radio Access Networks |
| BSS | Basic Service Set |
| CFP | Contention Free Period |
| CP | Contention Period |
| DCF | Distributed Coordination Function |
| DCS | Dynamic Channel Selection |
| DFS | Dynamic Frequency Selection |
| DIFS | Distributed Coordination Function Interframe Space |
| DLC | Data Link Control |
| ETSI | European Telecommunications Standards Institute |
| H/2 | HiperLAN/2 |
| HiperLAN | High Performance Local Area Network |
| IEEE | Institute of Electrical and Electronics Engineers |
| MAC | Medium Access Control |
| MT | Mobile Terminal |
| NAV | Network Allocation Vector |
| PC | Point Coordinator |
| PCF | Point Coordination Function |
| QoS | Quality of Service |
| SIFS | Short Interframe Space |
| STA | Station |
| TBTT | Target Beacon Transmission Time |

1. A system containing a first network with assigned first stations and a second network with second stations, whereby a hybrid-coordinator sends a beacon at a target beacon transmission time with setting a first parameter, whereby upon receiving this beacon by second stations, the second stations extract and evaluate the first parameter and thus set timers to a appropriate duration, not to initiate any data transmission during the respective time, whereby after sending this beacon the hybrid coordinator is able to initiate the transmission of data of the first network without underlying interference from the second network.

2. A system according to claim 1, characterized in that the transmission of data according to the first network will be embedded in one or more specific parts of the frame of the second network.

3. A system according to claim 1, characterized in that the transmission of data according to the first network will be embedded in a contention period right after the contention free period of the second network.

4. A system according to claim 1, characterized in that the transmission of data according to the first network will be embedded in a contention free period of the second network.

5. A method to coordinate a first network with assigned first stations and a second network with second stations, whereby a hybrid-coordinator sends a beacon at a target beacon transmission time with setting a first parameter, whereby upon receiving this beacon by second stations, the second stations extract and evaluate the first parameter and thus set timers to a appropriate duration, not to initiate any data transmission during the respective time, whereby after sending this beacon the hybrid coordinator is able to initiate the transmission of data of the first network without underlying interference from the second network.

6. A hybrid-coordinator for coordinating a first network with assigned first stations and a second network with second stations, whereby the hybrid-coordinator sends a beacon at a target beacon transmission time with setting a first parameter, whereby the first parameter comprises a indication for the second stations not to initiate any data transmission during a specific time-period, whereby after sending this beacon the hybrid coordinator is able to initiate the transmission of data of the first network without underlying interference from the second network.
